(19) United States
(12) Patent Application Publication
(10) Pub. No.: US 2011/0267682 A1
(43) Pub. Date: Nov. 3, 2011

(54) PROXIMITY COUPLED ATHERMAL OPTICAL PACKAGE COMPRISING LASER SOURCE AND COMPOUND FACET WAVELENGTH CONVERSION DEVICE

(75) Inventors: Venkata Adisehaiah Bhagavatula, Big Flats, NY (US); Satish Chandra Chaparala, Painted Post, NY (US); John Himmelreich, Horseheads, NY (US); Lawrence Charles Hughes, JR., Corning, NY (US)

(73) Assignee: CORNING INCORPORATED, Corning, NY (US)

(21) Appl. No.: 13/178,782

(22) Filed: Jul. 8, 2011

Related U.S. Application Data
(62) Division of application No. 12/471,666, filed on May 26, 2009.

(51) Int. Cl. G02F 1/35

(52) U.S. Cl. 359/326

(57) ABSTRACT

Particular embodiments of the present disclosure bring an SHG crystal, or other type of wavelength conversion device, into close proximity with a laser source to eliminate the need for coupling optics, reduce the number of package components, and reduce package volume. According to one embodiment of the present disclosure, an optical package is provided comprising a laser source and a wavelength conversion device. The laser source is positioned such that the output face of the laser source is proximity-coupled to a waveguide portion of the input face of the wavelength conversion device. The input face of the wavelength conversion device comprises an α-cut facet and β-cut facet. The α-cut facet of the input face is oriented at a horizontal angle α, relative to the waveguide of the wavelength conversion device to permit proximity coupling of the output face of the laser source and the input face of the wavelength conversion device. The β-cut facet of the input face is oriented at a horizontal angle β, relative to the waveguide of the wavelength conversion device to cooperate with the horizontal tilt angle of the device to reduce back reflections from the input face of the wavelength conversion device into the laser source. Additional embodiments are disclosed.

### BACKGROUND

The present disclosure relates to frequency-converted laser sources, laser projection systems and, more particularly, to optical packaging configurations for laser sources and multi-color laser projectors in applications such as cell phones, PDAs, laptop computers, etc.

### BRIEF SUMMARY

The present inventors have recognized that frequency-converted laser sources and multi-color laser projectors must be compact to be feasible for many projection applications. This object is particularly challenging in multi-color projection systems requiring three independent color sources (red, green, blue). Although red and blue sources are reasonably compact, frequency-converted green laser sources present a particular challenge in this respect because they commonly utilize an IR laser source and a second harmonic generation (SHG) crystal or some other type of wavelength conversion device. Active or passive coupling optics are often utilized to ensure proper alignment of the IR pump light with the waveguide of the SHG crystal. The package may also include hardware for enhancing mechanical stability over a wide temperature range. Together, these components increase overall package volume and operational complexity.

Particular embodiments of the present disclosure bring the SHG crystal, or other type of wavelength conversion device, into close proximity with the laser source to eliminate the need for coupling optics, reduce the number of package components, and reduce package volume. The package is also designed to be passively athermal over a wide operating temperature range. According to one embodiment of the present disclosure, an optical package is provided comprising a laser source and a wavelength conversion device. The laser source is positioned such that the output face of the laser source is proximity-coupled to a waveguide portion of the input face of the wavelength conversion device. The input face of the wavelength conversion device comprises an α-cut facet and β-cut facet. The α-cut facet of the input face is oriented at a horizontal angle α, relative to the waveguide of the wavelength conversion device to permit proximity coupling of the output face of the laser source and the input face of the wavelength conversion device. The β-cut facet of the input face is oriented at a horizontal angle β, relative to the waveguide of the wavelength conversion device to cooperate with the horizontal tilt angle of the device to reduce back reflections from the input face of the wavelength conversion device into the laser source. Additional embodiments are disclosed.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIGS. 1 and 2 illustrate a proximity-coupled optical package according to one embodiment;

FIGS. 3A and 3B are schematic plan views of further alternatives for providing a wavelength conversion device in an optical package similar to that illustrated in FIGS. 1 and 2;

FIGS. 4A-4D are schematic elevation views illustrating the manner in which a wavelength conversion device may be tilted vertically in an optical package similar to that illustrated in FIGS. 1 and 2;

FIGS. 5 and 6 illustrate an optical package according to an embodiment where the laser source and wavelength conversion device are provided on a common substrate including a mounting groove for the wavelength conversion device;

FIGS. 7-10 illustrate an optical package according to an embodiment where the wavelength conversion device is supported by a riser substrate; and

FIGS. 11-14 illustrate an optical package according to an embodiment where the laser source and wavelength conversion device are supported by a common substrate comprising a suspension slot.

### DETAILED DESCRIPTION

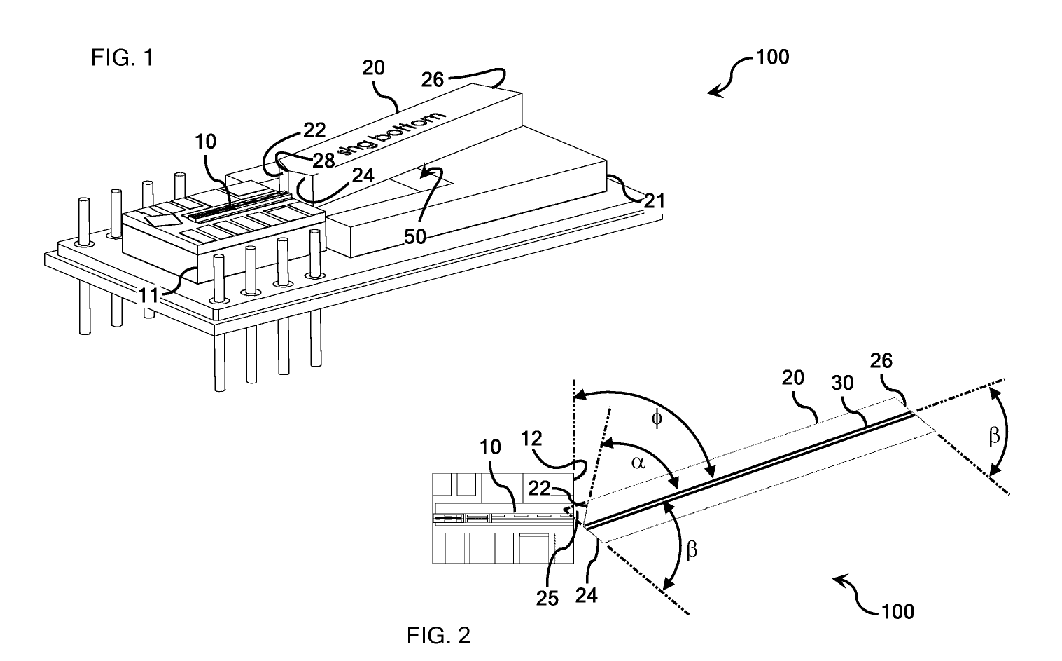

Referring initially to FIG. 1 and FIG. 2, an optical package 100 according to one embodiment of the present disclosure is illustrated. FIG. 1 illustrates an optical package 100 comprising a laser source 10 and a wavelength conversion device 20. The wavelength conversion device 20 comprises an input face formed of an α-cut facet 22 and β-cut facet 24, an output face 26, and a waveguide 30 extending from the input face to the output face 26. The laser source 10 is positioned such that an output face 12 of the laser source 10 is proximity-coupled to the waveguide portion of the input face of the wavelength conversion device 20.

For the purposes of describing and defining the present disclosure, it is noted that a laser source can be considered to be “proximity-coupled” to a wavelength conversion device when the proximity of the output face of the laser source and the input face of the wavelength conversion device is the primary mechanism for coupling an optical signal from the laser source into the waveguide of the wavelength conversion device. Typical proximity-coupled packages will not employ collimating, focusing, or other types of coupling optics in the optical path between the laser source and the wavelength conversion device, although it is contemplated that some proximity-coupled packages may employ relatively insignificant optical elements between the laser and wavelength conversion device, such as optical films, protective elements, correction lenses, optical filters, optical diffusers, etc. In any case, for proximity-coupled packages, it is contemplated that the proximity of the laser and the wavelength conversion device will be responsible for at least 30% of the optical intensity coupled from the laser to the wavelength conversion device.

FIG. 2, where like structure is indicated with like reference numerals, illustrates the input face of the wavelength conversion device 20 in greater detail. As is noted above, the input face of the wavelength conversion device comprises an α-cut facet 22 and β-cut facet 24. The α-cut facet 22 of the input face is oriented at a horizontal angle α, relative to the waveguide 30 of the wavelength conversion device 20 to permit proximity coupling of the output face 12 of the laser source 10 and the input face of the wavelength conversion device 20. The β-cut facet 24 of the input face is oriented at a horizontal angle β, relative to the waveguide 30 of the wavelength conversion device 20 and cooperates with the horizontal tilt angle φ to reduce back reflections from the input face of the wavelength conversion device 20 into the laser source 10, which are commonly caused by light being reflected from the input face of a waveguide back into the acceptance cone of the output face of a laser source.

To facilitate the aforementioned proximity coupling, the angle α and the angle β should be selected to satisfy the following relation:

α<180°−β<φ.

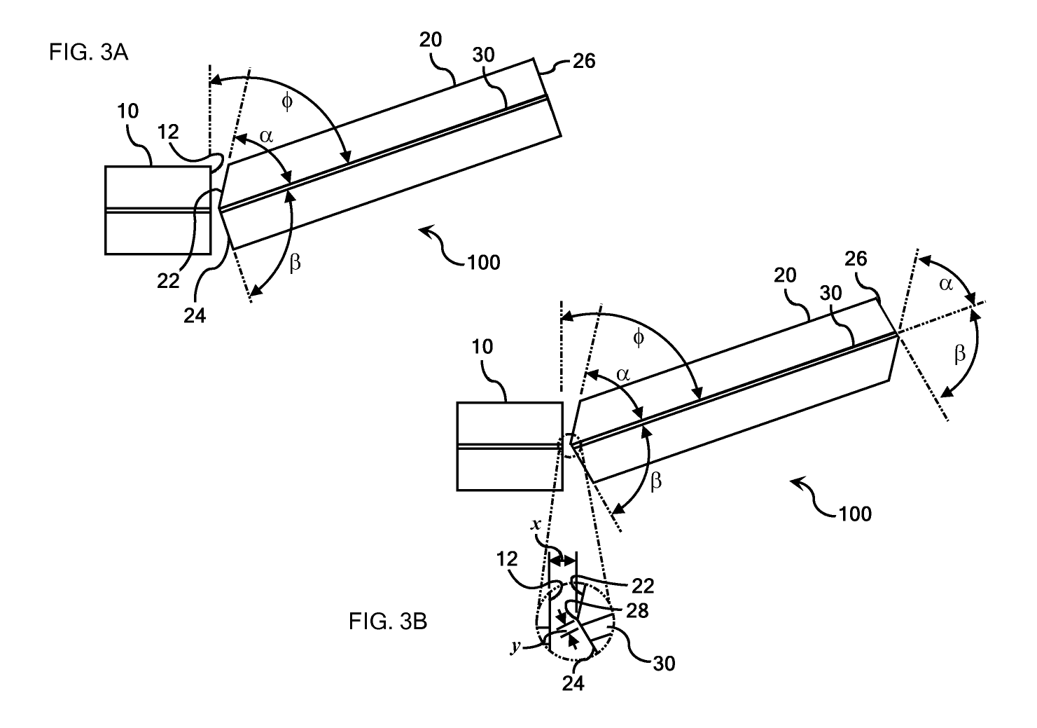

As is illustrated in FIGS. 2, 3A and 3B, where like structure is indicated with like reference numerals, and where the waveguide 30 is oriented at a horizontal tilt angle φ relative to the output face 12 of the laser source 10, to further enhance proximity coupling, the angle a of the α-cut facet 22 is typically established at a value that is less than the horizontal tilt angle φ, as measured along a common direction from the waveguide 30. Alternatively, it may merely be sufficient to ensure that the α-cut facet 22, the β-cut facet 24, or both are oriented at acute angles relative to the waveguide 30 of the wavelength conversion device 20, which, for the purposes of describing and defining the present disclosure, is an angle less than 90°. For example, and not by way of limitation, the horizontal tilt angle φ may fall between approximately 75° and approximately 85°, the angle φ of the α-cut facet 22 may be about 10° to about 15° less than the horizontal tilt angle φ, and the angle β of the β-cut facet 24 may be about 80°. For optimal light coupling into the waveguide, the angles φ and β are related and can be determined by the well known refraction formula.

Regardless of the particular angles selected for the angle α and the angle β, the α-cut facet 22 and the β-cut facet 24 will form an apex 28 on the input face. As is illustrated in FIG. 3B, the apex 28 is spaced from the waveguide portion of the input face, typically by a waveguide spacing γ of less than approximately 20 μm. Further, the apex 28 is spaced from the output face 12 of the laser source 10 by an interfacial spacing x, which can be on the order of less than approximately 5 μm. Proximity coupling is facilitated in the illustrated embodiments because the relative sign and magnitude of the angles α and β yield a vacated body portion 25, which would otherwise be present in a wavelength conversion device not including the α-cut facet 22. In a proximity-coupled package, the vacated body portion 25, the bounds of which are illustrated with dashed lines in FIG. 2, breaches the output face 12 of the laser source 10 and illustrates the degree to which the α-cut facet 22 enhances proximity coupling. Stated differently, the α-cut facet 22 removes portions of the wavelength conversion device 20 that would otherwise present a physical obstruction to close proximity coupling. This removed portion is illustrated in FIG. 2 as the vacated body portion 25. This removed portion can be minimized by placing the waveguide closer to the appropriate edge of the waveguide conversion device.

The laser source 10 is preferably proximity-coupled to the waveguide 30 portion of the wavelength conversion device 20 without the use of intervening optical components. For the purposes of describing and defining the present disclosure, it is noted that “intervening optical components” are those whose optical properties are not necessary to support the functionality of the laser source or the wavelength conversion device. For example, intervening optical components would include a collimating or focusing lens positioned in the optical path between the laser source and the wavelength conversion device but would not include anti-reflective or reflective coatings formed on the output face of the laser or on the input face of the wavelength conversion device.

In the embodiments of FIGS. 2 and 3A, the output face 26 of the wavelength conversion device is oriented to match the angle β of the β-cut facet 24. Alternatively, as is illustrated in FIG. 3B, it is contemplated that the output face 26 of the wavelength conversion device 20 may comprise an additional pair of facets that mirror the α-cut facet and the β-cut facet of the input face of the wavelength conversion device.

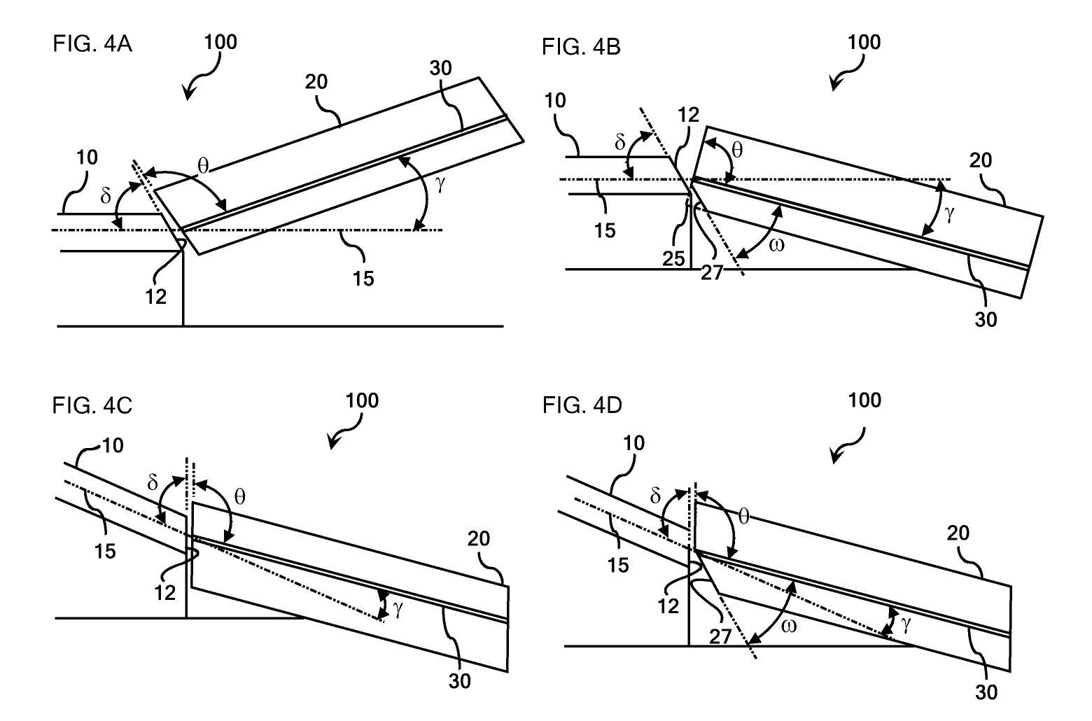

FIGS. 4A-4D are schematic elevation views illustrating the manner in which a wavelength conversion device 20 may be tilted vertically in an optical package 100 to complement the corresponding tilt of the output face 12 of the laser source 10. More specifically, referring collectively to FIGS. 4A-4D, in some applications, the output face 12 of the laser source 10 will be oriented at a vertical angle δ relative to the optical axis 15 of the laser source 10. This angle is typically on the order of a few degrees but has been exaggerated in FIGS. 4A-4D for illustrative purposes. Similarly, the input face of the wavelength conversion device 20 will be oriented at a vertical angle θ relative to the waveguide of the wavelength conversion device. The vertical angle θ typically exceeds 90° but can take a variety of values depending on the particular wavelength conversion device 20 selected for the optical package, including the orthogonal angle illustrated in FIG. 4B. The vertical angle θ of the input face and the vertical tilt angle y of the wavelength conversion device 20, which is taken relative to the optical axis 15, are selected to at least partially compensate for optical misalignment introduced by the laser output face angle δ. These angles are related by the refraction formula and depend on the refractive indices and angles of the laser diode and wavelength conversion devices.

Referring to FIGS. 4B and 4D, to further facilitate proximity coupling in some embodiments, it may be preferable to provide the input face of the wavelength conversion device 20 with an ω-cut facet 29 oriented at a vertical angle ω, relative to the waveguide 30. The ω-cut facet 29 functions in a manner similar to the α-cut facet 22 of FIGS. 1-3 in that it removes portions of the wavelength conversion device 20 that would otherwise present a physical obstruction to close proximity coupling. See, for example, the vacated body portion 25 illustrated in FIG. 4B.

To help preserve optimum optical coupling in proximity-coupled optical packages where the wavelength conversion device 20 and the laser source 10 are supported by independent stacks, the respective coefficients of thermal expansion of the independent stacks can be matched to account for thermal expansion of the respective stacks, which could otherwise cause losses in coupling efficiency between the laser source 10 and the wavelength conversion device 20 as the optical package is subjected to temperature excursions during normal operation. In many cases, it will not be difficult to athermalize the proximity-coupled optical packages illustrated herein because the absence of coupling optics permit reduced stack heights, making it easier to match the respective coefficients of thermal expansion of the independent stacks.

For example, referring to FIG. 1, where the laser source 10 is supported by a laser stack 11 and the wavelength conversion device 20 is supported by a converter stack 21, the optical package 100 can be athermalized by ensuring that the respective coefficients of thermal expansion of the two independent stacks 11, 21 are matched. For example, in one embodiment the coefficients of thermal expansion of the two independent stacks 11, 21 are matched to within approximately 0.5 μm or, more preferably, to within 0.1 μm, over the operating temperature range of the optical package 100. In other For example, the laser stack 11 may comprise aluminum nitride, Au metallization pads and molybdenum and the converter stack 21 may comprise silicon. For the purposes of defining and describing the present disclosure, it is noted that a “stack” may comprise any number of layers. Additionally, it is contemplated that the degree to which the coefficients of thermal expansion are matched may be increased or decreased depending on the desired degree of coupling efficiency.

FIG. 1 also illustrates the use of an underlying thermal void 50 to mitigate thermal gradients that develop within the wavelength conversion device 20 during operation of the optical package 100. Because the laser source 10 is proximity-coupled to the wavelength conversion device 20, significant thermal gradients can be induced along the length of the wavelength conversion device 20 due to a difference in temperature between the input face and the output face 26 of the wavelength conversion device 20, particularly when the optical package 100 is passively cooled, for example by natural convection. These thermal gradients can decrease the efficiency of the wavelength conversion device 20 by shifting the phase matching wavelength beyond the spectral width of the fundamental laser light. As is illustrated in FIG. 1, the underlying thermal void 50 can be provided in the vicinity of the input face of the wavelength conversion device 20 to help thermally isolate the input end of the wavelength conversion device 20 and reduce operational thermal gradients along the wavelength conversion device 20.

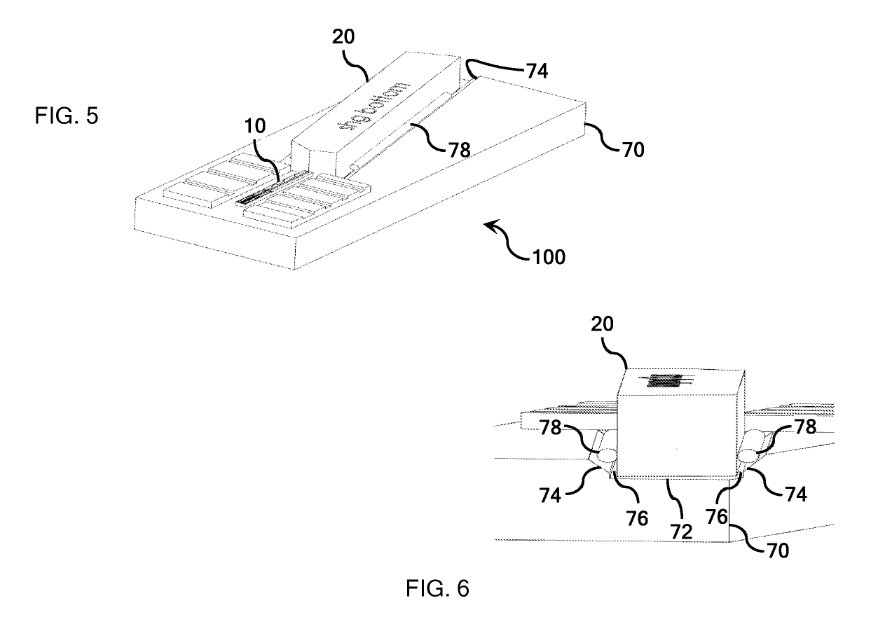

Another example of athermalization is illustrated in the embodiment of FIGS. 5 and 6, where the wavelength conversion device 20 and laser source 10 are supported by a common substrate 70 comprising a mounting groove 72. The mounting groove 72 comprises tapered wall portions 74 and a minimum lateral dimension z exceeding a corresponding lateral dimension z′ of the wavelength conversion device 20 such that, when the wavelength conversion device 20 is positioned in the mounting groove 72 between the tapered wall portions 74, longitudinal gaps 76 extend between the wavelength conversion device 20 and the mounting groove 72. Longitudinally-oriented structures 78 are positioned between the tapered wall portions 74 of the mounting groove 72 and the sides of the wavelength conversion device 20. For the purposes of describing and defining the present disclosure, it is noted that longitudinal refers to the direction from the input face of the wavelength conversion device 20 to the output face 26 of the wavelength conversion device 20.

In the embodiment of FIGS. 5 and 6, the longitudinally-oriented structures 78, which may comprise a single longitudinal structure, like a cylinder, or a series of discrete elements arranged longitudinally, like a series of spheres, serve to secure the wavelength conversion device 20 in the optical package 100 with the aid of an adhesive. The longitudinally-oriented structures 78 can be of any material such as metals, fused silica, etc and are typically placed symmetrically on the both sides of the wavelength conversion device 20. Any type of movement caused by adhesive shrinkage during adhesive curing will typically be nullified in configurations of the illustrated type. In addition, the proposed technique requires minimal adhesive and at the same time, provides a robust joint. It also enables nearly zero clearance proximity coupling and can be used in a variety of optical package configurations. The common substrate may comprise materials including, but not limited to, Molybdenum, Copper Tungsten, “410” stainless steel, etc. In addition to metals, insulator or dielectric materials are also contemplated for use in achieving the aforementioned athermalization.

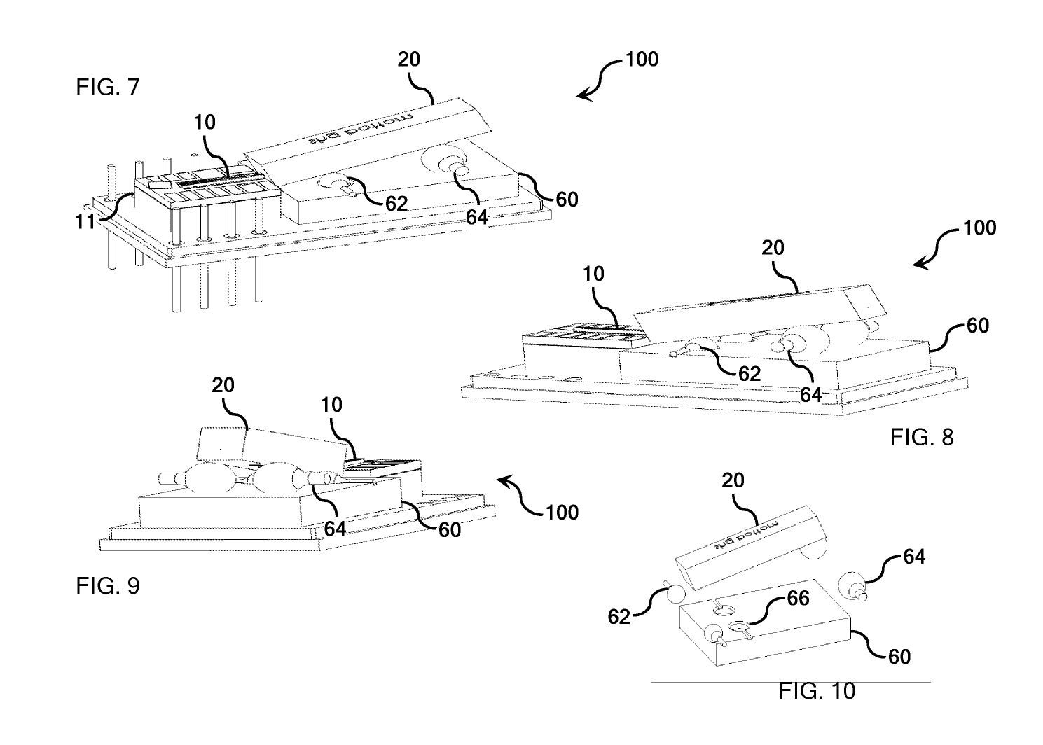

In the embodiment of FIGS. 7-10, the wavelength conversion device 20 are supported by input end silica risers 62 and output-end silica risers 64 secured to a riser substrate 60. The input end silica risers 62 and the output end silica risers 64 are configured to help thermally isolate the wavelength conversion device 20 and tilt the input face of the wavelength conversion device 20 vertically relative to the output face 12 of the laser source 10. As is shown most clearly shown in FIG. 10, the input end silica risers 62 may be secured in recessed portions 66 formed in the riser substrate 60. It is contemplated by the present disclosure that the recessed portions 66 can also complement the shape of the output end silica risers 64. It is further contemplated by the present disclosure that the input end silica risers 62 and output end silica risers 64 can be made of any material that improves athermalization.

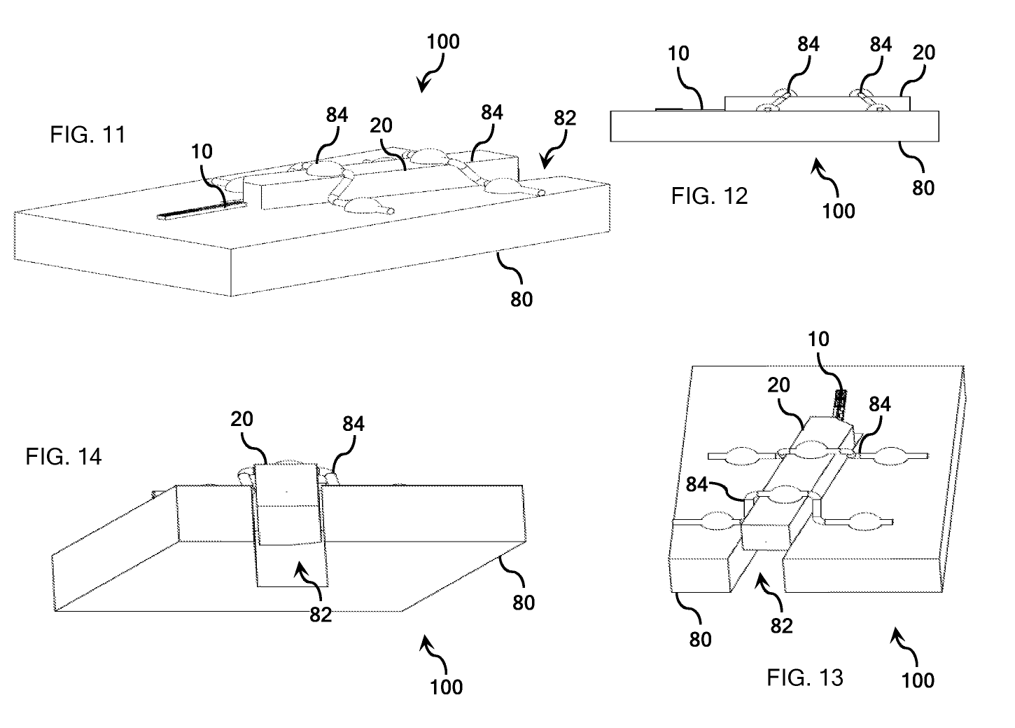

In the embodiment of FIGS. 11-14, the wavelength conversion device 20 and laser source 10 are supported by a common substrate 80 comprising a suspension slot 82. The wavelength conversion device 20 is suspended within the suspension slot 82 by a pair of suspension bridges 84, each of which is secured to the wavelength conversion device 20 and to the substrate 80 on opposite sides of the suspension slot 82 by, for example, a thermally insulating adhesive, a laser welded joint, or other securing means. The suspended configuration of FIGS. 11-14 helps to thermally isolate the wavelength conversion device 20 and provides an effective means of athermalizing the optical package 100. In addition, it is contemplated that the suspension bridges 84 may be attached to the substrate 80 within holes, slots, or other types of recesses made within the substrate 80. If enough clearance is provided for the bridges 84 within the recesses, manufacturing can be made more efficient by allowing for adjustments in the alignment of the wavelength conversion device 20.

The suspension bridges 84 may be made of any material with sufficient coefficient of thermal expansion, such as steel, and may have a variety of cross sectional shapes, for example cylindrical, such that the suspension bridges 84 can self adjust during assembly. An example of such a self adjustment is the rotation of the suspension bridges 84 during the initial alignment of the laser source 10 and waveguide 30. The suspension bridges 84 may also be of any of a variety of shapes, including those with large radii of curvature, such as the illustrated “Q” shape, a square “U” shape, etc.

The suspension bridges 84 are particularly advantageous because they can be configured to permit alignment of the wavelength conversion device 20 in at least two degrees of freedom relative to the laser source 10. In addition, the suspension bridges 84 can be configured such that, when a temperature excursion occurs in the suspension bridges 84, forces generated by a longitudinal component of thermal expansion in the bridges 84 oppose each other along a longitudinal dimension of the waveguide 30, thereby substantially achieving athermalization in the longitudinal direction.

The suspension bridges 84 can also be configured such that, when a temperature excursion occurs in the bridges 84 and the wavelength conversion device 20, displacement of the suspension bridges 84 in a direction orthogonal to the longitudinal dimension of the waveguide 30 opposes displacement of the wavelength conversion device 20 in the opposite direction.

It is noted that recitations herein of a component of the present disclosure being “configured” in a particular way, to embody a particular property, or function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

It is noted that terms like “preferably,” “commonly,” and “typically,” when utilized herein, are not utilized to limit the scope of the claimed invention or to imply that certain features are critical, essential, or even important to the structure or function of the claimed invention. Rather, these terms are merely intended to identify particular aspects of an embodiment of the present disclosure or to emphasize alternative or additional features that may or may not be utilized in a particular embodiment of the present disclosure.

For the purposes of describing and defining the present disclosure it is noted that the terms “substantially” and “approximately” are utilized herein to represent the inherent degree of uncertainty that may be attributed to any quantitative comparison, value, measurement, or other representation. The terms “substantially” and “approximately” are also utilized herein to represent the degree by which a quantitative representation may vary from a stated reference without resulting in a change in the basic function of the subject matter at issue.

Having described the subject matter of the present disclosure in detail and by reference to specific embodiments thereof, it will be apparent that modifications and variations are possible without departing from the scope of the invention defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

1. (canceled)

2. An optical package comprising a laser source and a wavelength conversion device, wherein:
the wavelength conversion device comprises an input face, an output face, and a waveguide extending from the input face to the output face;
the laser source is positioned such that an output face of the laser source is proximity-coupled to a waveguide portion of the input face of the wavelength conversion device;
the waveguide of the wavelength conversion device is oriented at a horizontal tilt angle φ relative to the output face of the laser source;
the input face of the wavelength conversion device comprises an α-cut facet and β-cut facet;
the α-cut facet of the input face is oriented at a horizontal angle α, relative to the waveguide of the wavelength conversion device to permit proximity coupling of the output face of the laser source and the input face of the wavelength conversion device;
the β-cut facet of the input face is oriented at a horizontal angle β, relative to the waveguide of the wavelength conversion device and cooperates with the horizontal tilt angle φ to reduce back reflections from the input face of the wavelength conversion device into the laser source;
α+β<180° and α<φ;
the laser source defines an optical axis and the output face of the laser source is oriented at a vertical angle δ relative to the optical axis;
the input face of the wavelength conversion device is oriented at a vertical angle θ relative to the waveguide of the wavelength conversion device;
the waveguide of the wavelength conversion device is oriented at a vertical tilt angle γ relative to the optical axis of the laser source; and
the vertical angle θ and the vertical tilt angle γ are selected to at least partially compensate for optical misalignment introduced by the laser output face angle δ.

3. An optical package as claimed in claim 2 wherein the input face of the wavelength conversion device further comprises an ω-cut facet oriented at a vertical angle ω, relative to the waveguide of the wavelength conversion device to permit proximity coupling of the output face of the laser source and the input face of the wavelength conversion device.

4. An optical package as claimed in claim 2 wherein the α-cut facet of the input face is oriented at an acute angle α, relative to the waveguide of the wavelength conversion device.

5. An optical package as claimed in claim 2 wherein the β-cut facet of the input face is oriented at an acute angle β, relative to the waveguide of the wavelength conversion device.

6. An optical package as claimed in claim 2 wherein:
the α-cut facet of the input face is oriented at an acute angle α, relative to the waveguide of the wavelength conversion device; and
the β-cut facet of the input face is oriented at an acute angle β, relative to the waveguide of the wavelength conversion device.

7. An optical package as claimed in claim 2 wherein the output face of the wavelength conversion device comprises an additional pair of facets that mirror the α-cut facet and the β-cut facet of the input face of the wavelength conversion device.

8. An optical package as claimed in claim 2 wherein:
the laser source is positioned such that the output face of the laser source is proximity-coupled to the waveguide portion of the input face of the wavelength conversion device by an interfacial spacing x;
the waveguide of the wavelength conversion device is oriented at a horizontal tilt angle φ relative to the output face of the laser source;
the relative sign and magnitude of the angles α and β yield a vacated body portion at the input face of the wavelength conversion device; and
the horizontal tilt angle φ and the interfacial spacing x are such that the vacated body portion breaches the output face of the laser source.

9. An optical package as claimed in claim 2 wherein the laser source is proximity-coupled to the waveguide portion of the wavelength conversion device without the use of intervening optical components.

10. An optical package as claimed in claim 2 wherein the laser source is proximity-coupled to the waveguide portion of the wavelength conversion device by a proximity spacing x of less than approximately 20 μm or less than approximately 10 μm.

11. An optical package as claimed in claim 2 wherein:
the wavelength conversion device and laser source are supported by independent stacks; and
the respective coefficients of thermal expansion of the independent stacks are matched to within approximately 0.1 μm and approximately 0.5 μm over the operating temperature range of the optical package.

12. An optical package as claimed in claim 2 wherein an underlying thermal void is formed in a base supporting the wavelength conversion device to thermally isolate an input end of the wavelength conversion device and reduce operational thermal gradients along the wavelength conversion device.

13. An optical package as claimed in claim 2 wherein:
the wavelength conversion device and laser source are supported by a common substrate comprising a mounting groove;
the mounting groove of the common substrate comprises tapered wall portions and a minimum lateral dimension exceeding a corresponding lateral dimension of the wavelength conversion device such that, when the wavelength conversion device is positioned in the mounting groove between the tapered wall portions longitudinal gaps extend between the wavelength conversion device and the mounting groove; and
longitudinally-oriented structures are positioned between the tapered wall portions of the mounting groove and lateral sides of the wavelength conversion device.

14. An optical package as claimed in claim 2 wherein:
the wavelength conversion device is supported by input end silica risers and output-end silica risers secured to a riser substrate; and
the input end silica risers and the output end silica risers are configured to tilt the input face of the wavelength conversion device relative to the output face of the laser source.

15. An optical package as claimed in claim 2 wherein:
the wavelength conversion device and laser source are supported by a common substrate comprising a suspension slot;
the wavelength conversion device is suspended within the suspension slot by a pair of suspension bridges, each of which is secured to the substrate on opposite sides of the suspension slot; and
the suspension bridges are configured to permit alignment of the wavelength conversion device in at least two degrees of freedom relative to the laser source.

16. An optical package as claimed in claim 15 wherein the suspension bridges are configured such that, when a temperature excursion occurs in the suspension bridges, forces generated by a longitudinal component of thermal expansion in the suspension bridges oppose each other along a longitudinal dimension of the waveguide.

17. An optical package as claimed in claim 15 wherein the suspension bridges are configured such that, when a temperature excursion occurs in the suspension bridges and the wavelength conversion device, displacement of the suspension bridges in a vertical dimension of the waveguide opposes displacement of the wavelength conversion device in an opposite direction.

18. An optical package comprising a laser source and a wavelength conversion device, wherein:
the wavelength conversion device comprises an input face, an output face, and a waveguide extending from the input face to the output face;
the laser source is positioned such that an output face of the laser source is proximity-coupled to a waveguide portion of the input face of the wavelength conversion device;
the wavelength conversion device and laser source are supported by a common substrate comprising a mounting groove;
the mounting groove of the common substrate comprises tapered wall portions and a minimum lateral dimension exceeding a corresponding lateral dimension of the wavelength conversion device such that, when the wavelength conversion device is positioned in the mounting groove between the tapered wall portions longitudinal gaps extend between the wavelength conversion device and the mounting groove; and
longitudinally-oriented structures are positioned between the tapered wall portions of the mounting groove and lateral sides of the wavelength conversion device.

19. An optical package comprising a laser source and a wavelength conversion device, wherein:
the wavelength conversion device comprises an input face, an output face, and a waveguide extending from the input face to the output face;
the laser source is positioned such that an output face of the laser source is proximity-coupled to a waveguide portion of the input face of the wavelength conversion device;
the wavelength conversion device is supported by input end silica risers and output-end silica risers secured to a riser substrate; and
the input end silica risers and the output end silica risers are configured to tilt the input face of the wavelength conversion device relative to the output face of the laser source.

20. An optical package comprising a laser source and a wavelength conversion device, wherein:
the wavelength conversion device comprises an input face, an output face, and a waveguide extending from the input face to the output face;
the laser source is positioned such that an output face of the laser source is proximity-coupled to a waveguide portion of the input face of the wavelength conversion device;
the wavelength conversion device and laser source are supported by a common substrate comprising a suspension slot;
the wavelength conversion device is suspended within the suspension slot by a pair of suspension bridges, each of which is secured to the substrate on opposite sides of the suspension slot; and
the suspension bridges are configured to permit alignment of the wavelength conversion device in at least two degrees of freedom relative to the laser source.
